(19) United States
(12) Patent Application Publication
(10) Pub. No.: US 2014/0257675 A1
(43) Pub. Date: Sep. 11, 2014

(54) SYSTEM AND METHOD FOR INDICATING ENGINE POWER BAND INFORMATION ON A TACHOMETER DISPLAY

(71) Applicants: Jacob Ivan Wasser, Dublin, OH (US); Alex Frank Mattioli, Marysville, OH (US)

(72) Inventors: Jacob Ivan Wasser, Dublin, OH (US); Alex Frank Mattioli, Marysville, OH (US)

(73) Assignee: HONDA MOTOR CO., LTD., Tokyo (JP)

(21) Appl. No.: 14/196,357

(22) Filed: Mar. 4, 2014

Related U.S. Application Data
(60) Provisional application No. 61/774,330, filed on Mar. 7, 2013.

(51) Int. Cl. F02D 28/00

(52) U.S. Cl. CPC F02D 28/00
USPC 701/110

(57) ABSTRACT

A vehicle is described. The vehicle includes an engine, a drivetrain coupled to the engine, and a computing device including a memory and a processor coupled to the memory. The processor is configured to determine a peak horsepower of the engine and a first rotational speed of the engine associated with the peak horsepower, and determine a peak torque of the engine and a second rotational speed of the engine associated with the peak torque. The vehicle additionally includes a tachometer coupled to the computing device and including a tachometer display. The tachometer is configured to indicate, on the tachometer display, the first rotational speed and the second rotational speed provided by the computing device.

### CROSS-REFERENCE TO RELATED APPLICATIONS

This application claims the benefit of priority to U.S. Provisional Patent Application No. 61/774,330, filed Mar. 7, 2013, the entire disclosure of which is incorporated herein by reference.

### BACKGROUND OF THE INVENTION

The field of the invention relates generally to vehicles, and more particularly, to systems and methods for indicating engine power band information on a tachometer display of a vehicle.

Performance in an engine in a vehicle is provided by operating the engine between a rotational speed associated with a peak torque and a rotational speed associated with a peak horsepower. For example, when trying to accelerate the vehicle quickly, it is desirable to maintain the engine close to the peak horsepower point on the engine's horsepower versus rotations-per-minute (RPM) curve. Furthermore, known internal combustion engines generally operate most efficiently within an RPM range between an RPM value associated with a peak torque and an RPM value associated with a peak horsepower. For example, if an engine's peak torque is determined to be generated by the engine at 2500 RPM and the engine's peak horsepower is determined to be generated at 5000 RPM, the engine is said to have a power band of 2500 RPM to 5000 RPM. Known engines operate most efficiently at rotational speeds within the power band.

A power band of a vehicle is conventionally determined using a dynamometer. A driver wishing to optimize engine performance and/or efficiency relies on test results from the dynamometer to influence their driving. In some known vehicles, a tachometer display includes a first static indicator that corresponds to an RPM value associated with a peak torque of the vehicle's engine, and a second static indicator that corresponds to an RPM value associated with a peak horsepower of the engine. The peak torque and the peak horsepower are each determined at a predetermined time and the static indicators are subsequently positioned on the tachometer display at that point in time. Accordingly, if at a later point in time the engine rotational speed associated with the peak torque and/or the engine rotational speed associated with the peak horsepower is changed due to modification, age, and/or wear, at least one of the static indicators on the tachometer display may no longer be correct. As such, engine performance and/or efficiency may be adversely affected.

### BRIEF DESCRIPTION OF THE INVENTION

In one aspect, a system for indicating engine power band information on a tachometer is provided. The system includes a computing device including a memory and a processor coupled to the memory. The computing device is configured to be coupled to a tachometer and to at least one sensor. The tachometer is configured to indicate a first rotational speed associated with an engine power band and a second rotational speed associated with the engine power band. The at least one sensor is configured to detect and transmit at least acceleration data to the computing device. The memory includes processor-executable instructions that, when executed by the processor, cause the computing device to determine a peak horsepower of the engine and a first rotational speed of the engine, based at least partially on the acceleration data received from the at least one sensor, wherein the first rotational speed is associated with the peak horsepower. The instructions further cause the computing device to determine a peak torque of the engine and a second rotational speed of the engine, wherein the second rotational speed is associated with the peak torque, and transmit a signal to the tachometer to indicate the first rotational speed and the second rotational speed.

A method for indicating engine power band information on a tachometer is provided. The method is performed by a computing device including a processor and a memory coupled to the processor. The computing device is coupled to a tachometer and to at least one sensor. The tachometer is configured to indicate a first rotational speed associated with an engine power band and a second rotational speed associated with the engine power band. The at least one sensor is configured to detect and transmit at least acceleration data to the computing device. The method includes receiving, by the computing device, the acceleration data from the at least one sensor, determining, by the computing device, a peak horsepower of the engine and a first rotational speed of the engine, wherein the first rotational speed is associated with the peak horsepower, determining, by the computing device, a peak torque of the engine and a second rotational speed of the engine, wherein the second rotational speed is associated with the peak torque, and transmitting, by the computing device, a signal to the tachometer to indicate the first rotational speed and the second rotational speed.

In another aspect, a vehicle is provided. The vehicle includes an engine, a drivetrain coupled to the engine, and a computing device including a memory and a processor coupled to the memory. The processor is configured to determine a peak horsepower of the engine and a first rotational speed of the engine associated with the peak horsepower, and determine a peak torque of the engine and a second rotational speed of the engine associated with the peak torque. The vehicle additionally includes a tachometer coupled to the computing device and including a tachometer display. The tachometer is configured to indicate, on the tachometer display, the first rotational speed and the second rotational speed provided by the computing device.

### BRIEF DESCRIPTION OF THE DRAWINGS

FIG. 1 is a schematic diagram of an exemplary vehicle containing an exemplary system for use in indicating power band information on a tachometer display.

FIG. 2 is a block diagram of an exemplary computing device that may be used in the system of FIG. 1.

FIG. 3 is a diagram of an exemplary tachometer display that may be used in the system of FIG. 1.

FIG. 4 is a flowchart of an exemplary process that may be implemented to indicate engine power band information using the system of FIG. 1.

### DETAILED DESCRIPTION OF THE INVENTION

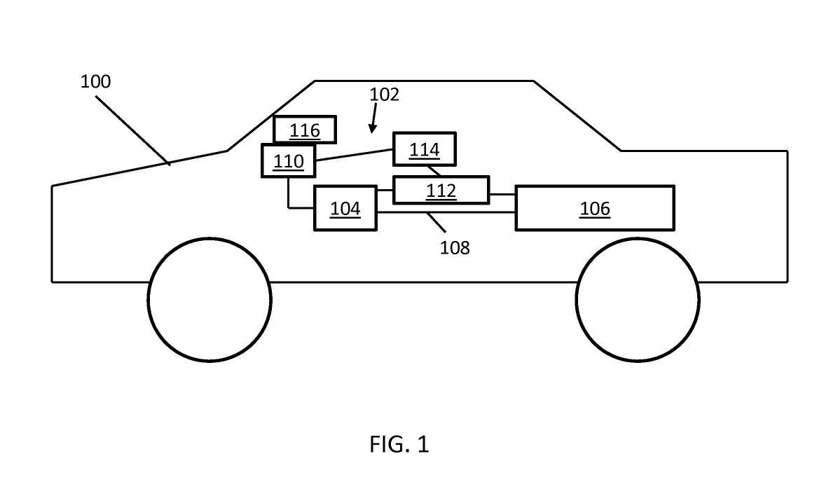

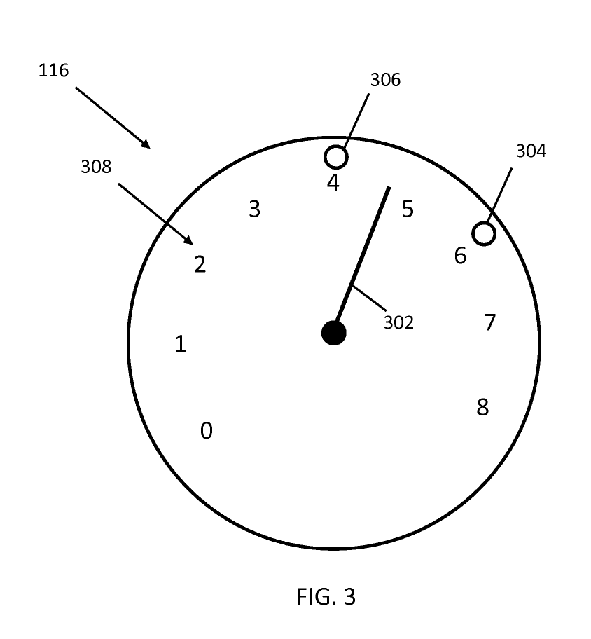

FIG. 1 is a schematic diagram of an exemplary vehicle 100 containing an exemplary system 102 for use in indicating power band information of an engine 104 of vehicle 100 on a tachometer 110. Engine 104 is coupled to drivetrain 106 via a shaft 108, for example, a crankshaft. A tachometer 110 is coupled to engine 104 and includes a tachometer display 116. Tachometer 110 determines a current rotational speed of engine 104, and more specifically, of shaft 108, at any given time and displays the current rotational speed on tachometer display 116. At least one sensor 112 is coupled to engine 104 and drivetrain 106. Sensor 112 detects torque produced by engine 104 and power produced by engine 104. Further, sensor 112 detects a rotational speed of engine 104. In some embodiments, sensor 112 includes multiple sensors. Coupled to sensor 112 is a computing device 114. In an exemplary embodiment, computing device 114 may be a vehicle engine control unit (ECU) and/or included within the ECU. Using torque data, power data, acceleration data, and rotational speed data transmitted to computing device 114 by sensor 112, computing device 114 determines a rotational speed of engine 104 associated with a peak torque of engine 104 and a rotational speed of engine 104 associated with a peak power of engine 104. Computing device 114 is coupled to tachometer 110 to cause tachometer 110 to indicate, using a first indicator 306 (FIG. 3), the rotational speed of engine 104 associated with the peak torque and to indicate, using a second indicator 304 (FIG. 3), the rotational speed of engine 104 associated with the peak power.

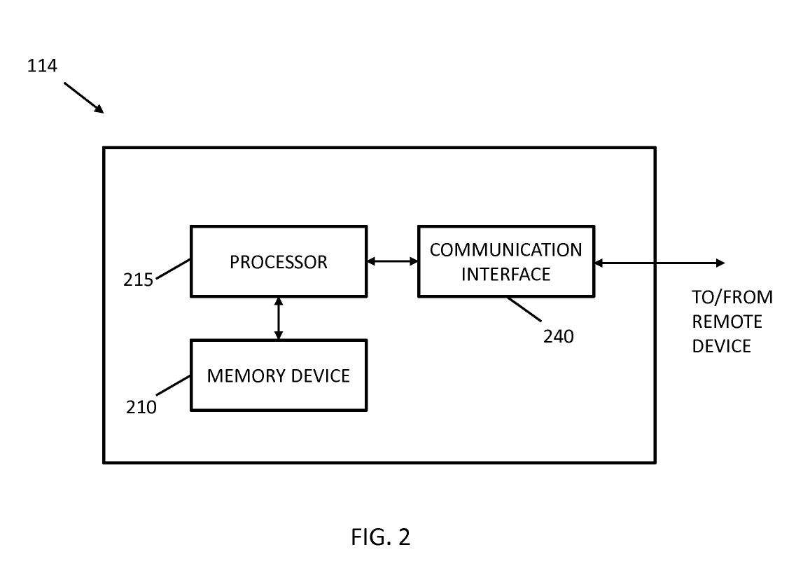

FIG. 2 is a block diagram of computing device 114. In the example embodiment, computing device 114 includes at least one memory device 210 and a processor 215 that is coupled to memory device 210 for executing instructions. In some implementations, executable instructions are stored in memory device 210. In the exemplary implementation, computing device 114 performs one or more operations by executing the executable instructions with processor 215. For example, processor 215 may execute instructions that cause computing device 114 to receive, as inputs, data from sensor 112 pertaining to torque, power, and rotational speed of engine 104, and acceleration of vehicle 100. Additionally, processor 215 may execute instructions that cause computing device 114 to determine, from the received data, a peak power and associated rotational speed of engine 104. Additionally, processor 215 may execute instructions that cause computing device 114 to determine, from the received data, a peak torque and associated rotational speed of engine 104. Further, processor 215 may execute instructions that cause computing device 114 to transmit a signal or otherwise cause tachometer 110 to concurrently indicate the rotational speed associated with the peak torque of engine 104 and the rotational speed associated with the peak power of engine 104.

Processor 215 may include one or more processing units (e.g., in a multi-core configuration). Further, processor 215 may be implemented using one or more heterogeneous processor systems in which a main processor is present with secondary processors on a single chip. As another illustrative example, processor 215 may be a symmetric multi-processor system containing multiple processors of the same type. Further, processor 215 may be implemented using any suitable programmable circuit including one or more systems and microcontrollers, microprocessors, reduced instruction set circuits (RISC), application specific integrated circuits (ASIC), programmable logic circuits, field programmable gate arrays (FPGA), and any other circuit capable of executing the functions described herein.

In the exemplary implementation, memory device 210 is one or more devices that enable information such as executable instructions and/or other data to be stored and retrieved. Memory device 210 may include one or more computer readable media, such as, without limitation, dynamic random access memory (DRAM), static random access memory (SRAM), a solid state disk, and/or a hard disk. Memory device 210 may be configured to store, without limitation, source code, object code, configuration data, execution events and/or any other type of data.

In the exemplary implementation, computing device 114 includes a communication interface 240 coupled to processor 215. Communication interface 240 communicates with one or more devices, for example sensor 112 and tachometer 110. To communicate with such devices, communication interface 240 may include, for example, a wired data communication adapter and/or a wireless data communication adapter.

FIG. 3 is an illustration of an exemplary tachometer display 116 (e.g., face) of tachometer 110. Tachometer display 116 may include, for example, a thin film transistor (TFT) display, a liquid crystal display (LCD), an organic LED (OLED) display, an “electronic ink” display, and/or a mechanical display. As described above, tachometer 110 is coupled to engine 104 and to computing device 114. Tachometer 110 displays, on tachometer display 116, a current rotational speed of engine 104 at any given time. In the exemplary embodiment, tachometer 110 displays the current rotational speed of engine 104 using a needle 302 that points to any position within a range of numbers 308. The current rotational speed may be displayed, for example, in rotations per minute. Tachometer 110 additionally indicates, with a first indicator 304, a rotational speed of engine 104 associated with a peak horsepower of engine 104, and indicates, with a second indicator 306, a rotational speed of engine 104 associated with a peak torque of engine 104. The rotational speeds indicated by first indicator 304 and second indicator 306 are determined by computing device 114, as described above. The range of rotational speeds between first indicator 304 and second indicator 306 define a power band for engine 104. In other words, if vehicle 100 is operated such that the rotational speed of engine 104 is between the rotational speed indicated by first indicator 304 and the rotational speed indicated by second indicator 306, the acceleration and efficiency of engine 104 and vehicle 100 is facilitated to be increased. In alternative embodiments, tachometer 110 may instead indicate the power band with a single indicator that spans length of the power band, for example, extending from first indicator 304 to second indicator 306.

Changes to engine 104, for example, due to modifications to engine 104 or decreased performance due to wear and/or age, may cause the peak torque, peak power, and/or rotational speeds associated therewith to change. System 102 allows a user to detect such changes and determine the current peak torque, peak power, and associated rotational speeds of the vehicle 100. Accordingly, by viewing tachometer 110, a user of vehicle 100 may know the power band for vehicle 100 as of the last power band determination.

In the exemplary embodiment, computing device 114 is configured to determine the rotational speeds at which engine 104 produces the peak torque and/or the peak power, based on signals received from sensors 112. For example, sensors 112 may include a strain gauge configured to measure a torque applied to a shaft within drivetrain 106, a pressure sensor to measure a pressure within engine 104 (e.g., a cylinder pressure), a shaft tachometer to measure a rotational speed of the shaft, an accelerometer to measure an acceleration of vehicle 100, and/or an engine tachometer to measure a rotational speed of an engine component.

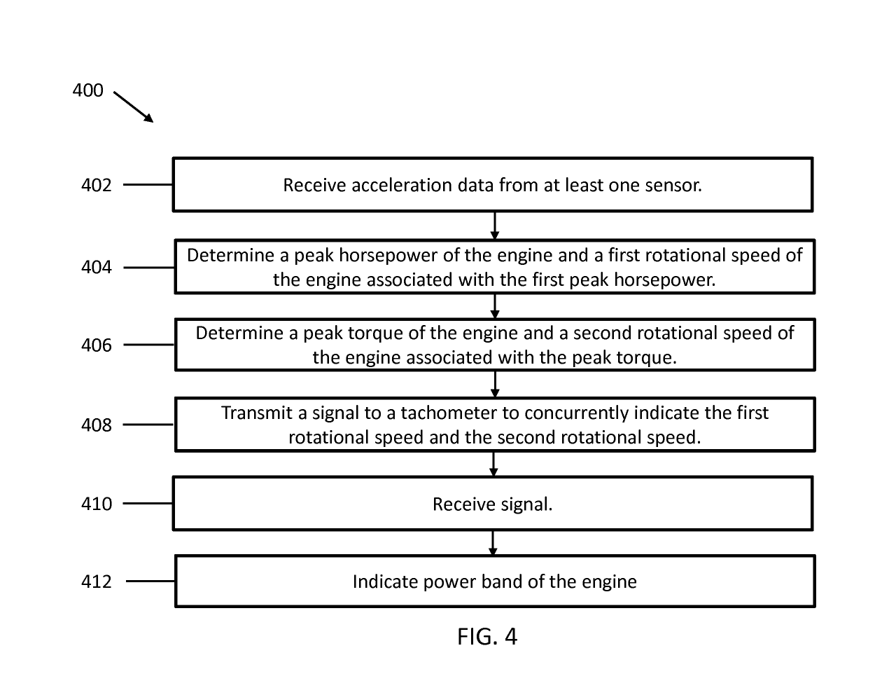

FIG. 4 is a flowchart of an exemplary process 400 that may be implemented to indicate engine power band information on tachometer 110 (FIG. 1). Process 400 may be implemented using system 102 (FIG. 1). In the exemplary embodiment, a user initiates process 400. In some implementations, computing device 114 receives a signal representing an instruction to begin recording rotational speeds of engine 104 and calculating instantaneous horsepower values, as described herein. Process 400 is performed during at least one test run of vehicle 100, for example, at a racing facility such as a drag strip, where the user is able to run engine 104 at a maximum engine output (i.e., throttle fully open) through a desired RPM range. The user is instructed to perform steps typically performed when determining horsepower using a chassis dynamometer, for example, selecting a transmission gear (e.g., second or third gear), maintaining the vehicle throttle fully open, and operating vehicle 100 at speeds where the RPM starts slightly below an expected lower RPM of the power band and continues past an expected higher RPM of the power band as vehicle 100 accelerates.

In the exemplary embodiment, process 400 includes receiving 402, for example, at computing device 114, acceleration data corresponding to acceleration of vehicle 100 from sensor 112. Computing device 114 also receives vehicle mass data corresponding to the mass of vehicle 100. The user may provide the vehicle mass data to computing device 114, computing device 114 may retrieve vehicle mass data from a memory device, for example, memory device 210 (shown in FIG. 2) where it was previously stored, computing device 114 may determine the vehicle mass data one or more sensors (e.g., sensor 112) included in or on vehicle 100, and/or computing device 114 may obtain the vehicle mass data in any other manner that allows system 102 to function as described herein. Furthermore, computing device 114 receives at least one of time data and vehicle speed data from, for example, but not limited to, the vehicle ECU or a global positioning system (GPS) device included within vehicle 100. For example, in some implementations, sensor 112 may be or include a GPS device.

In the exemplary embodiment, process 400 includes determining 404 a peak horsepower of engine 104 and a first rotational speed of the engine associated with the peak horsepower. For example, during the vehicle test run, computing device 114 may continuously determine a metric horsepower of engine 104 based at least partially on the acceleration data received from sensor 112 and the vehicle mass data. More specifically, computing device 114 calculates instantaneous metric horsepower of engine 104 throughout the test run based at least partially on the vehicle mass data and acceleration data. The metric horsepower varies as the RPM increases. Computing device 114 records the metric horsepower and corresponding RPM values and determines the peak horsepower of engine 104 by identifying the maximum (i.e., greatest) metric horsepower calculated during the test run. Computing device 114 stores, for example, in memory device 210, the RPM value corresponding to the peak horsepower of engine 104 as the first rotational speed.

In the exemplary embodiment, process 400 also includes determining 406 a peak torque of engine 104 and a second rotational speed of engine 104. For example, computing device 114 may determine an instantaneous torque of engine 104 throughout the test run based at least partially on the instantaneous metric horsepower of engine 104 and the time data. Computing device 114 records the torque and corresponding RPM values and determines the peak torque of engine 104 by identifying the maximum (i.e., greatest) torque calculated during the test run. The second rotational speed of engine 104 is the rotational speed at which engine 104 produces the peak torque. Computing device 114 is further configured to store, for example, in memory device 210, the second rotational speed.

In the exemplary embodiment, process 400 also includes transmitting 408 at least one power band signal to tachometer 110. The at least one power band signal includes data corresponding to the first and second rotational speeds of engine 104. After receiving 410 the signal, tachometer 110 indicates the first rotational speed, for example with first indicator 304 (FIG. 3) and the second rotational speed, for example with second indicator 306 (FIG. 3), thereby indicating 412 the power band of engine 104.

Process 400 may be repeated, by performing additional test runs, to achieve higher accuracy in the power band determination. Process 400 may also be repeated throughout the life of vehicle 100. By performing process 400 at a later time, any changes to engine 104 and/or vehicle 100 that may affect the rotational speeds at which engine 104 produces a peak torque and peak power will be detected and tachometer 110 will indicate 412 the new rotational speeds associated with the peak torque and peak power.

A technical effect of systems and methods described herein includes at least one of: (a) receiving acceleration data from at least one sensor; (b) determining a peak horsepower of an engine and a first rotational speed of the engine, wherein the first rotational speed is associated with the peak horsepower; (c) determining a peak torque of the engine and a second rotational speed of the engine, wherein the second rotational speed is associated with the peak torque; and (d) transmitting a signal to a tachometer to indicate the first rotational speed and the second rotational speed.

As compared to known systems and methods for indicating engine power band information on a tachometer of a vehicle, the systems and methods described herein enable a tachometer in a vehicle to indicate power band information that accounts for changes in the performance of the engine due, for example, to age, wear, and/or modification. Accordingly, vehicles equipped and operated in accordance with the systems and methods described herein may indicate power band information on a tachometer with increased accuracy when performance characteristics of the engine change.

Exemplary embodiments of systems and methods for indicating engine power band information on a tachometer are described above in detail. The systems and methods described herein are not limited to the specific embodiments described herein, but rather, components of the systems and/or steps of the methods may be utilized independently and separately from other components and/or steps described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for indicating engine power band information on a tachometer, said system comprising a computing device comprising a memory and a processor coupled to said memory, wherein said computing device is configured to be coupled to a tachometer and to at least one sensor, wherein the tachometer is configured to indicate a first rotational speed associated with an engine power band and a second rotational speed associated with the engine power band, and wherein the at least one sensor is configured to detect and transmit at least acceleration data to said computing device, wherein said memory includes processor-executable instructions that, when executed by said processor, cause said computing device to:
determine a peak horsepower of the engine and a first rotational speed of the engine, based at least partially on the acceleration data received from the at least one sensor, wherein the first rotational speed is associated with the peak horsepower;
determine a peak torque of the engine and a second rotational speed of the engine, wherein the second rotational speed is associated with the peak torque; and
transmit a signal to the tachometer to indicate the first rotational speed and the second rotational speed.

2. The system of claim 1, wherein said computing device is further configured to store data corresponding to the first rotational speed and the second rotational speed in said memory.

3. The system of claim 1, wherein said computing device is further configured to determine the peak horsepower by:
determining a plurality of instantaneous metric horsepower values throughout a test run of said vehicle, based at least partially on acceleration data and vehicle mass data; and
identifying the greatest instantaneous metric horsepower value determined during the test run and a corresponding rotations per minute (RPM) value, wherein the RPM value is the first rotational speed.

4. The system of claim 3, wherein said computing device is further configured to retrieve the vehicle mass data from said memory.

5. The system of claim 1, wherein said computing device is further configured to determine the peak torque by:
determining a plurality of instantaneous metric horsepower values throughout a test run of said vehicle, based at least partially on acceleration data and vehicle mass data;
determining a plurality of instantaneous torque values throughout the test run, based at least partially on the plurality of instantaneous metric horsepower values and time data; and
identifying the greatest instantaneous metric torque value determined during the test run and a corresponding rotations per minute (RPM) value, wherein the RPM value is the second rotational speed.

6. A method for indicating engine power band information on a tachometer, said method is performed by a computing device including a processor and a memory coupled to the processor, wherein the computing device is coupled to a tachometer and to at least one sensor, wherein the tachometer is configured to indicate a first rotational speed associated with an engine power band and a second rotational speed associated with the engine power band, and wherein the at least one sensor is configured to detect and transmit at least acceleration data to the computing device, the method comprising:
receiving, by the computing device, the acceleration data from the at least one sensor;
determining, by the computing device, a peak horsepower of an engine and a first rotational speed of the engine, wherein the first rotational speed is associated with the peak horsepower;
determining, by the computing device, a peak torque of the engine and a second rotational speed of the engine, wherein the second rotational speed is associated with the peak torque; and
transmitting, by the computing device, a signal to the tachometer to indicate the first rotational speed and the second rotational speed.

7. The method of claim 6, further comprising receiving, from the at least one sensor, data pertaining to at least one of a mass of a vehicle, an acceleration of the vehicle, a rotational speed of a component of the engine, a speed of the vehicle, a time, a torque produced by the engine, and a power produced by the engine.

8. The method of claim 6, further comprising receiving, by the computing device, data from at least one of a strain gauge configured to measure a torque applied to a shaft within a drivetrain, a pressure sensor configured to measure a pressure within the engine, a shaft tachometer configured to measure a rotational speed of the shaft coupled to the engine, an accelerometer configured to measure an acceleration of a vehicle, and an engine tachometer to measure a rotational speed of a component of the engine.

9. The method of claim 6, further comprising storing data corresponding to the first rotational speed and the second rotational speed in the memory.

10. The method of claim 6, further comprising determining the peak horsepower by:
determining a plurality of instantaneous metric horsepower values throughout a test run of a vehicle, based at least partially on acceleration data and vehicle mass data; and
identifying the greatest instantaneous metric horsepower value determined during the test run and a corresponding rotations per minute (RPM) value, wherein the RPM value is the first rotational speed.

11. The method of claim 10, further comprising retrieving the vehicle mass data from the memory.

12. The method of claim 6, further comprising determining the peak torque by:
determining a plurality of instantaneous metric horsepower values throughout a test run of a vehicle, based at least partially on acceleration data and vehicle mass data;
determining a plurality of instantaneous torque values throughout the test run, based at least partially on the plurality of instantaneous metric horsepower values and time data; and
identifying the greatest instantaneous metric torque value determined during the test run and a corresponding rotations per minute (RPM) value, wherein the RPM value is the second rotational speed.

13. A vehicle comprising:
an engine;
a drivetrain coupled to said engine;
a computing device including a memory and a processor coupled to said memory, said processor configured to:
determine a peak horsepower of said engine and a first rotational speed of said engine associated with the peak horsepower, and
determine a peak torque of said engine and a second rotational speed of said engine associated with the peak torque;
a tachometer coupled to said computing device and including a tachometer display, wherein said tachometer is configured to indicate, on said tachometer display, the first rotational speed and the second rotational speed provided by said computing device.

14. The vehicle of claim 13, further comprising at least one sensor configured to determine data pertaining to at least one of a mass of said vehicle, an acceleration of said vehicle, a rotational speed of a component of said engine, a speed of said vehicle, a time, a torque produced by said engine, and a power produced by said engine, wherein said at least one sensor is coupled to said computing device and configured to provide the data to said computing device.

15. The vehicle of claim 13, further comprising at least one sensor including at least one of a strain gauge configured to measure a torque applied to a shaft within said drivetrain, a pressure sensor configured to measure a pressure within said engine, a shaft tachometer configured to measure a rotational speed of the shaft coupled to said engine, an accelerometer configured to measure an acceleration of said vehicle, and an engine tachometer to measure a rotational speed of a component of said engine, wherein said at least one sensor is coupled to said computing device and configured to provide data to said computing device.

16. The vehicle of claim 13, wherein said processor is further configured to store data corresponding to the first rotational speed and the second rotational speed in said memory.

17. The vehicle of claim 13, wherein said processor is further configured to determine the peak horsepower by:
determining a plurality of instantaneous metric horsepower values throughout a test run of said vehicle, based at least partially on acceleration data and vehicle mass data; and
identifying the greatest instantaneous metric horsepower value determined during the test run and a corresponding rotations per minute (RPM) value, wherein the RPM value is the first rotational speed.

18. The vehicle of claim 17, wherein said processor is further configured to retrieve the vehicle mass data from said memory.

19. The vehicle of claim 13, wherein said processor is further configured to determine the peak torque by:
determining a plurality of instantaneous metric horsepower values throughout a test run of said vehicle, based at least partially on acceleration data and vehicle mass data;
determining a plurality of instantaneous torque values throughout the test run, based at least partially on the plurality of instantaneous metric horsepower values and time data; and
identifying the greatest instantaneous metric torque value determined during the test run and a corresponding rotations per minute (RPM) value, wherein the RPM value is the second rotational speed.

20. The vehicle of claim 13, wherein said tachometer display comprises:
a first indicator configured to visually indicate the first rotational speed; and
a second indicator configured to visually indicate the second rotational speed.
